(19) United States
(12) Patent Application Publication
(10) Pub. No.: US 2026/0092145 A1
(43) Pub. Date: Apr. 2, 2026

(54) DIELS-ALDER CROSSLINKED POLYURETHANES

(71) Applicant: The Government of the United States of America, as represented by the Secretary of the Navy, Arlington, VA (US)

(72) Inventors: Nickolaus Weise, Alexandria, VA (US); Spencer Giles, Lake Ridge, VA (US); Brian Rasley, Fairbanks, AK (US); Jeffrey Lundin, Burke, VA (US)

(73) Assignee: The Government of the United States of America, as represented by the Secretary of the Navy, Arlington, VA (US)

(21) Appl. No.: 19/341,046

(22) Filed: Sep. 26, 2025

Related U.S. Application Data
(60) Provisional application No. 63/700,170, filed on Sep. 27, 2024.

(51) Int. Cl. C08G 73/06; C08J 3/24

(52) U.S. Cl. CPC C08G 73/0611; C08J 3/247; C08G 2261/3228; C08J 2379/04

(57) ABSTRACT

A polymer and a method of making the polymer from the below maleimide monomer having maleimidyl groups and the below furan monomer having furyl groups. The value n is a positive integer. The monomers are combined to form a composition, and at least one of the maleimidyl groups is reacted with at least one of the furyl groups to form a polymer comprising at least one crosslinking group show below. The polymer can be heated to remove the crosslinks.

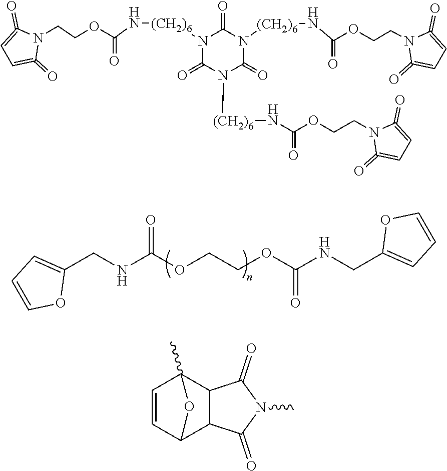

### REFERENCE TO RELATED APPLICATIONS

This application claims the benefit of U.S. Provisional Application No. 63/700,170, filed on Sep. 27, 2024. The provisional application and all other publications and patent documents referred to throughout this nonprovisional application are incorporated herein by reference.

### TECHNICAL FIELD

The present disclosure is generally related to polyurethanes.

### DESCRIPTION OF THE RELATED ART

Many current high-performance exterior topcoats are based upon polyurethane chemistries, which require the use of chemicals such as di- and poly-isocyanates that are sensitive to moisture and detrimental to human health and the environment.¹ Polymer coatings, or paints, are used extensively throughout society with polyurethanes comprising one of the most common classes of polymers, particularly in applications that require high performance and solvent durability. Polyurethane based coatings are used to impart improved aesthetics, protect the substrate from environmental degradation, reduce corrosion, and affect surface properties, as well as others. Polyurethane-based coatings are conventionally two-component solvent-based or one-component water-borne formulations, both of which cure through the reaction of isocyanate and hydroxyl or amine groups to result in a robust, crosslinked thermoset polymer. These traditional exterior topcoats are thermosets which are irreversibly cross-linked polymer networks that provide robust chemical and mechanical durability for the protection of the underlying substrate.²⁻⁴ The irreversible nature of thermoset protective coatings provides benefits necessary to maintain equipment integrity through prevention of corrosion and weathering. A crosslinked backbone provides thermosets with robust thermomechanical properties and durability, and thus also results in inherent difficulties to remove for reapplication, recycling, and disposal. Alternatives to isocyanate-based coatings are necessary to reduce the usage of designated hazardous air pollutants (HAP) such as hexamethylene-1,6-diisocyanate (HDI) and improve long-term sustainability for performance platforms. Therefore, polyurethane-based thermosets with potential for reusability have been a focus of recent research efforts.

Diels-Alder (DA) covalent bonding relies on [4+2] cycloadditions to form new and reversible covalent bonds. Diels-Alder chemistry relies upon the dissociative mechanism in which the equilibrium between the associated and dissociated molecules can be manipulated thermally. Under operational conditions the forward reaction is favored and the associated crosslinks are formed. Under thermal treatment the dissociative reaction can be driven and the free diene and dienophile can be generated.⁵ As the polymeric materials are heated and the dissociated form is favored the polymer network can diffuse and new crosslinks between different diene and dienophile pairs can form. The DA forward and reverse reaction are an equilibrium process and because the reaction is thermally triggered the crosslink density can be modulated through temperature variations.⁵ Additionally, the respective rates at which the forward and reverse reaction occur, as well as the temperature range, are affected by the chemical structure proximal to the DA reactive components.⁶ As such, the DA reversible covalent network has been the subject of various self-healing investigations.⁷ One specific approach to produce self-healing, or recyclable, polymers has been to leverage the reversible covalent bond of DA chemistry.

Stevens and Jenkins provide a simple route for the crosslinking of polystyrene polymers with Diels-Alder through maleimide functionalization and crosslinking with a difurfuryl ester in which crosslinking was performed in 15 min at 80° C.⁸ This work demonstrated the feasibility of the Diels-Alder approach in polystyrene-based polymers, however polystyrene-based materials suffer from poor mechanical properties insufficient for coating applications. Significant work on molecular designs has been undertaken to create crosslinked networks with self-healing capabilities.^{9,10} These networks are robust with significant self-healing characteristics; however, the synthetic nature of the molecules limits their practical application. Schafer and Kickelbick¹¹ provide an approach to similar to Stevens and Jenkins in which polymer crosslinking is formed through pendant group functionality along the polymer backbone that allows for designing and tuning the polymer network. Inclusion of both furan and maleimide functionality into the backbone could limit overall crosslink density of the resultant polymer network. Additionally, incorporation of both diene and dienophile moieties into the polymer architecture provides some critical challenges including multistep monomer synthesis requiring a protecting group to prevent premature reactivity and subsequent removal of the protecting group at elevated temperatures (˜125° C.) under vacuum prior to use which is currently not desirable.¹² Another drawback with the current system is the utilization of a custom inorganic filler with potential limits on applicability. As such, there remains a significant opportunity to apply the dynamic crosslink approach to coating relevant polymer systems.

Another approach is the incorporation of DA chemistry into polyurethane polymeric systems. Currently there are three methods for DA PU chemistry, where the first approach employs adding polyols with DA functional groups into polymer backbones and linkages. The second approach functionalizes diol end group PU with furan pendants and synthesizing linear polymers where further crosslinking occurs with polymaleimides. The last method is where thermoplastic PU are post functionalized with furan or maleimide end groups and either crosslinked with polyfurans or polymaleimides. (Nellepalli et al.) Work done by Yu et. al. explored the use of various isocyanates such as HDI, 4,4′-dicylohexylmethane diisocyanate (HMDI), and isophorone diisocyanate (IPDI) in combination with polyether polyol (PTMEG-1000) and 2,2-bis(hydroxymethyl)propionic acid (DMPA) to develop polymer backbones with diverse physical properties. The multiple combinations were then subjected to the addition of a pre-bonded DA molecule of furfuranol and N-(2-hydroxyethyl)maleimide and crosslinked with hexamethylene diisocyanate timer (Tri-HDI) to develop a robust anti-corrosion PU coating. Gaina et al. developed urethane backbone with furan and maleimide end groups where the method of polymerization was the forward DA reaction developing a self-healing linear polymer. Irusta et al. found that by adding a singular furan group to IPDI via urethan chemistry and introducing bis-maleimide (BMI) to the system, DA chemistry was still observed and remained efficient even after multiple cycles of forward and reverse reactions only slightly decreasing after the third cycle. Truong et al. developed linear polymers with and without furan pendant groups to modulate crystallinity within the polymer system and was crosslinked by the addition of maleimide and Tri-HDI. This benefit from this was being able to have a stiff polymer that is soft enough to allow enough chain mobility for the DA reactions to occur.

### SUMMARY OF THE INVENTION

Disclosed herein is a method comprising: providing a maleimide monomer comprising maleimidyl groups and having formula 1, providing a furan monomer comprising furyl groups and having formula 2 wherein n is a positive integer, combining the maleimide monomer with the furan monomer to form a composition, and reacting at least one of the maleimidyl groups with at least one of the furyl groups to form a polymer comprising at least one crosslinking group having formula 3.

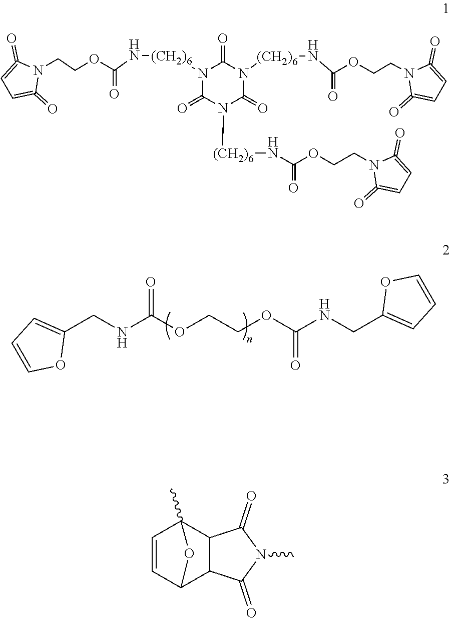

Also disclosed herein is a polymer made by the above method.

Also disclosed herein is maleimide monomer 1.

### BRIEF DESCRIPTION OF DRAWINGS

A more complete appreciation will be readily obtained by reference to the following Description of the Example Embodiments and the accompanying drawings.

FIG. 1 shows the reaction of the hexamethylene diisocyanate trimer (Desmo) with N-(2-hydroxyethyl)maleimide to form maleimide monomer 1.

FIG. 2 shows the reaction of the PEG with furfuryl isocyanate to form furyl monomer 2.

FIG. 3 shows the DA polymer design strategy showing the reaction of maleimide modified Desmodur with furan modified PEG.

FIG. 4 shows FTIR-ATR analysis of Desmodur N3300 (top) and Desmo-Mal product (bottom).

FIG. 5 shows NMR confirmation of DA-modified product Desmodur-maleimide.

FIG. 6 shows NMR confirmation of DA-modified product PEG furan.

FIGS. 7A-C show ATR-IR of PEG400-Furan (FIG. 7A), PEG6k-Furan (FIG. 7B), and furfuryl isocyanate (FIG. 7C).

FIG. 8 shows photographs of free films with varied PEG composition.

FIGS. 9A-B show ATR-IR of DA-modified monomers PEG6K-Furan (top) and Desmo-Mal (middle) and polymerization product PEG6K Desmo DA (bottom) (FIG. 9A) and magnified fingerprint region (FIG. 9B).

FIGS. 10A-B show ATR-IR of polymerized free films with varied PEG M_{w} (FIG. 10A) and magnified region (FIG. 10B).

FIGS. 11A-B show TGA of free films (FIG. 11A) and the relationship between degradation onset temperature and PEG M_{w} (FIG. 11B).

FIGS. 12A-B show a DSC overlay of PU-DA films (FIG. 12A) and magnified T_{g} region (FIG. 12B).

FIGS. 13A-B show DMA temperature sweeps of PU-DA films. FIG. 13A shows storage modulus and FIG. 13B shows tan δ.

FIG. 14 shows ssNMR of 100PEG 400 at 30° C. (top) and 80° C. (bottom).

FIG. 15 shows solvent resistance evaluation of 100PEG400 against: a) acetone, b) dichloromethane, c) DMSO, and d) MEK.

FIG. 16 shows evaluation of reprocessing at elevated temperatures.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a dynamic polymer network composed of polyurethane monomer starting materials with Diels-Alder (DA) compatible end groups to produce a crosslinked polymer that exhibits thermoreversible dynamic covalent bonding. These materials have potential to serve as dynamic coatings that exhibit thermoset characteristics at ambient temperatures, yet thermoplastic processability at elevated temperatures. The system leverages DA thermoreversibility in modified-monomers derived from conventional polyurethane coating feedstocks that exhibit desirable end-use properties compatible with military coating applications. Therefore, conventional PU coating starting materials were employed and selected for modification with terminal DA functionality.

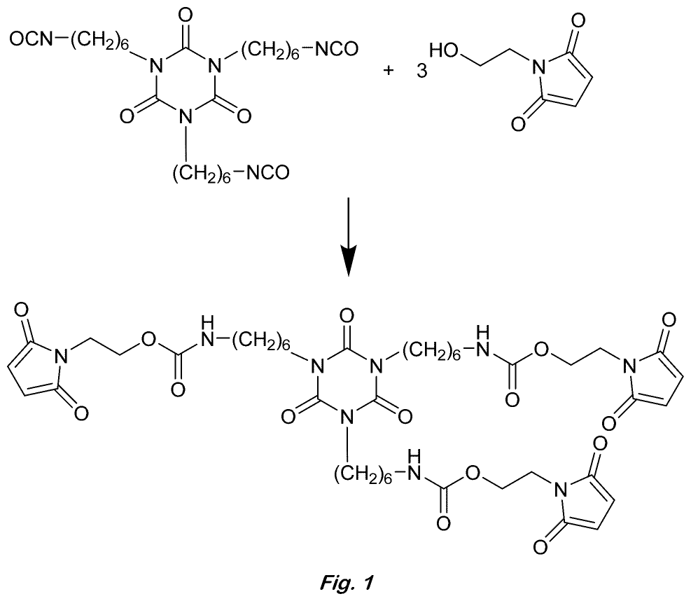

The commercially available tri-isocyanate, Desmodur 3300 (Desmo), and poly(ethylene glycol) (PEG) may be modified to produce monomers with end groups compatible with DA thermoreversible reactions. FIG. 1 shows the reaction of the hexamethylene diisocyanate trimer (Desmo) with N-(2-hydroxyethyl)maleimide to form maleimide monomer 1. Such reaction methods are known in the art. It is noted that the maleimide monomer may include some molecules with unreacted isocyanate groups.

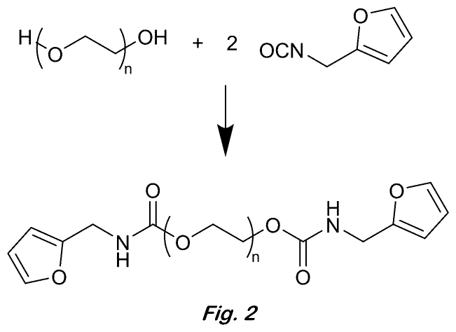

FIG. 2 shows the reaction of the PEG with furfuryl isocyanate to form furyl monomer 2. The value of n may be, for example, at least 8, and multiple PEGs having different values of n may be used. Such reaction methods are known in the art. It is noted that the furyl monomer may include some molecules with unreacted hydroxyl groups.

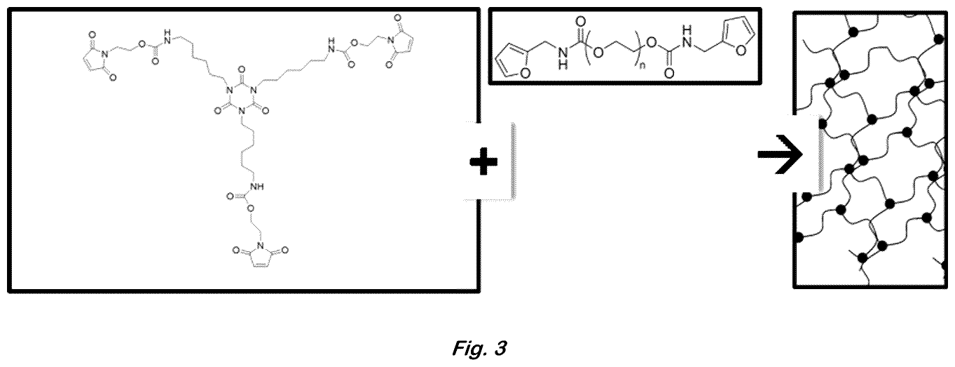

The maleimide monomer and the furan monomer are combined to form a composition and reacted to form a polymer comprising at least one crosslinking group 3. Such reaction methods are known in the art. The molar ratio of the maleimidyl groups to the furyl groups in the composition may be, for example, from 1.0:1 to 1.2:1. FIG. 3 shows the DA polymer design strategy showing the reaction of maleimide modified Desmodur with furan modified PEG to form a dynamic polymer network.

A potential benefit of this system is the potential to exhibit ambient temperature solvent resistance and also high temperature thermal repressibility, similar to a thermoplastic. Enable advanced coating that has the ability to be repaired for enhanced longevity and affords easy removal and recycling. The system demonstrates a highly crosslinked polymer with the strength and solvent resistance of thermosets and the reprocessability of thermoplastics. For polyurethane topcoat applications, the system is free of isocyanates (reducing health and environmental burden) and demonstrates self-healing and facile removal.

Disclosed is the design, synthesis, and evaluation of a dynamic covalent polymer network that leverages DA thermoreversibility in modified-monomers derived from conventional polyurethane coating feedstocks to target desirable end-use properties for potential military coating applications. A facile approach to generate DA monomers via modification of PU-based starting materials, commercially available tri-isocyanate and diol, with maleimide and furan end groups is demonstrated. ATR-IR and ssNMR confirmed the complete conversion of starting materials to their respective DA modified products for subsequent polymerization into dynamic covalent networks. A method to prepare free films that represents a facile and reproducible approach to create polymers to test and evaluate physical and thermomechanical properties is demonstrated. Free films with higher ratios of PEG400 as the diol component exhibited the most uniform and smooth free films. ATR-IR confirmed successful reaction of the Desmo-Mal and PEG6K-furan to form a DA-based polymer film. Good conversion of monomers to polymer was confirmed through appearance of polymer bands and decrease in free furan and maleimide bands. The polymer properties, specifically T_{g}, of the DA polymer series can be easily tuned by modulating the PEG-furan Mw. TGA and DMA results suggest that at elevated temperatures (ca. 120° C.) the retro-DA reaction begins to occur in the 100PEG400 resulting in reformation of the PEG-furan and Desmo-Mal monomers. The excellent solvent stability of the 100PEG400 polymer and high temperature thermal reformation of 100PEG400 was demonstrated, which together provide evidence of a cross-linked dynamic covalent network.

The polymer properties can be easily tuned by modulating the PEG-furan M_{w}. This has potential to serve as a facile approach to formulate DA coatings to target military coating specifications. A significant benefit of the PU-DA system is the potential to exhibit ambient temperature solvent resistance and also high temperature thermal repressibility, similar to a thermoplastic. The solvent durability shown by 100PEG400 is indicative of a crosslinked, or thermoset, polymer that has properties comparable to military coating specifications. The excellent solvent stability of the 100PEG400 polymer and high temperature thermal reformation of 100PEG400 was demonstrated, which together provide evidence of a cross-linked dynamic covalent network. These materials have potential to serve as a foundation for the development of a new class of dynamic coatings that exhibit thermoset characteristics at ambient temperatures, yet thermoplastic processability at elevated temperatures.

The following examples are given to illustrate specific applications. These specific examples are not intended to limit the scope of the disclosure in this application.

Materials—All solvents were purchased from Fisher Scientific, reagent grade, and used as received (Waltham, MA). Methyl acrylate (MA), butyl acrylate (BA), furfuryl acrylate (FA), furfuryl isocyanate, thionyl chloride, polyethylene glycol Mn 400 (PEG400), polyethylene glycol Mn 6000 (PEG6K), dicyclohexyl carbodiimide (DCC), and 4-dimethylaminopyridine (DMAP) were purchased from Millipore Sigma. N-(2-Hydroxyethyl)maleimide was purchased from Ambeed. Desmodur N3300 (Desmo) was provided by Covestro. All reagents were used without further purification.

ATR-IR Analysis—Compositional analysis of polymers was evaluated using an attenuated total reflectance-Fourier transform infrared (ATR-FTIR) spectrometer from Thermo Scientific (Nicolet iS50-FTIR spectrometer) equipped with an iS50 ATR attachment and Ge crystal. Background and sample spectra consisted of 128 scans averaged together with 4 cm¹ resolution at a scanner velocity of 10 kHz.

NMR—The nuclear magnetic resonance (NMR) spectra were recorded on a Bruker 400 MHz Ascend instrument using CDCl₃ (7.26 ppm) as the solvent.

Thermogravimetric analysis (TGA)—Thermal properties were measured by TGA on a TA Instrument Discovery TGA using platinum pans (100 μL). Thermal decomposition was evaluated by heating ramps performed at a heating rate of 10° C./min from room temperature to 600° C. under N₂. Degradation onset temperature was assigned at the temperature at which 90% mass remained. All thermal analyses were performed in triplicate.

Differential scanning calorimetry (DSC)—Thermal analysis was performed on a TA Instruments (New Castle, DE) Discovery Differential Scanning Calorimeter (DSC) to determine glass transition temperature (T_{g}) and crystalline phase transitions. Two successive temperature ramps were performed from −70° C. to 200° C. at a rate of 10° C./min, from which measurements were made on the second run. Origin software was used to analyze DSC and TGA data.

Gel fraction analysis—Gel fraction analysis was performed on each sample, which was weighed, soaked in THF for 24 hours, dried in vacuo for 24 h, and weighed again. Gel fraction was determined as the fraction of the final mass over the initial mass. Each sample was performed in triplicate.

Dynamic mechanical analysis (DMA)—DMA was performed on a TA Instruments (New Castle, DE) DMA Q800. Measurements were performed in the uniaxial tension mode. The tan δ measurements were acquired at an oscillation frequency of 1 Hz with an amplitude of 15 μm using a temperature range of −70° C. to 160° C.

Solid state nuclear magnetic resonance (ssNMR)—Solid state carbon-13 NMR spectra were acquired on a 600 MHz Bruker Avance-III system operating at a carbon frequency of 150.925 MHz. A standard cross-polarization (CP) experiment was set up and referenced using glycine. The sample was packed into a 4 mm zirconia rotor (˜60 mg) and spun at 15 kHz at the magic angle. Spectra were acquired with 512 scans, 5 second pulse delay, spectral width of 300 ppm, and centered at 100 ppm. This was done at both 30° C. and 50° C. allowing time for the temperature to stabilize before probe tuning and running the experiment.

Raw data was Fourier transformed with 50 Hz of line broadening, phased, and baseline corrected using TopSpin 3.6.2 (Bruker, Billerica, MA), and exported as csv files to be imported into Excel for making figures.

Solvent resistance evaluation—PU-DA free films were subjected to ambient temperature (20° C.) solvent resistance challenge to assess their feasibility to exhibit solvent durability similar to a convention cross-linked coating. PU-DA free films were divided into four samples and each was submerged in a strong solvent overnight. The four strong solvents used were acetone, dichloromethane, dimethylsulfoxide (DMSO), and methyl ethyl ketone (MEK). After solvent exposure, the solvents were visually inspected for detrimental effects of solvent, such as deformation and dissolution.

High temperature reprocessing evaluation—Fully cured PU-DA free films were subjected to high temperature reprocessing evaluation to assess their capability to reform and reprocess at elevated temperatures. Small 5 cm×1 cm samples of PU-DA were prepared, then cut in half, overlaid, placed between Teflon release films, and then subjected to 165° C. heat press for 17 h. The resulting reprocess polymer was analyzed with visual and macroscopic evaluation.

Synthesis—Synthesis of DA monomers employed the isocyanate and hydroxyl functional groups present in the PU starting materials and coupled to DA compounds with compatible chemistry (FIGS. 1 and 2). For the functionalization of Desmodur with maleimide, a round bottomed flask was charged with 7.927 mmol (4 g) of Desmodur N 3300, 23.78 mmol (3.356 g) of N-(2-hydroxyethyl)maleimide, 15 μL of dibutyltin dilaurate, 50 mL of acetonitrile, and a magnetic stir bar. The mixture was allowed to stir at 65° C. for 17 h upon which a white solid precipitated out of solution. The solvent was removed by rotary evaporation and dried under vacuum for 12 h. The product was used without further purification.

For the functionalization of PEG diol with furfuryl isocyanate, a round bottom flask was charged with 10 mmol (4 g) of PEG (MW 400), 20 mmol (2.462 g) furfuryl isocyanate, 15 μL of dibutyltin dilaurate, 50 mL of acetonitrile and a magnetic stir bar. The solution was allowed to stir at 65° C. for 17 h. The solvent was removed by rotary evaporation and dried under vacuum for 12 h. The product was used without further purification. These above steps were also used for the functionalization of PEG (MW 6000).

Characterization—Reaction products from the modification of isocyanate and diol starting materials were characterized with ATR-IR and NMR to confirm the reaction proceeded to completion.

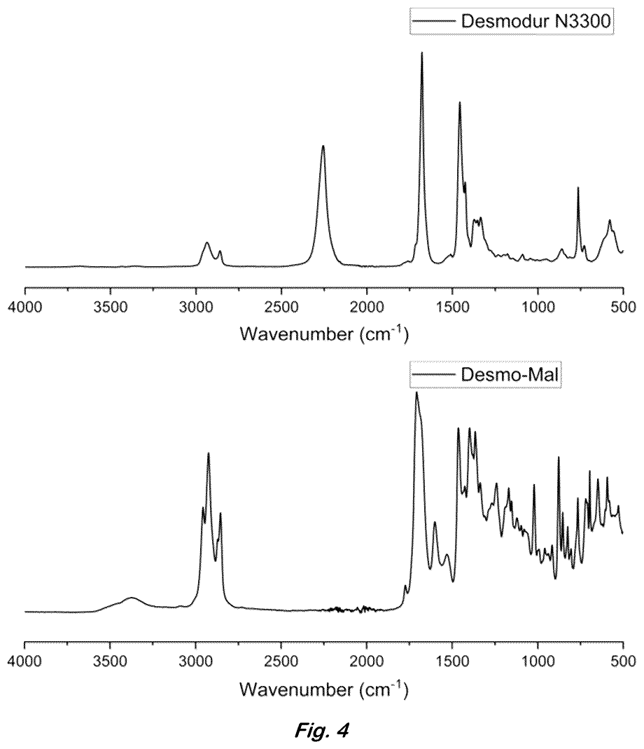

The Desmo-mal product was confirmed by monitoring the disappearance of the characteristic isocyanate peak centered at 2257 cm⁻¹ and the broadening of the carbonyl peak centered at 1711 cm⁻¹ (FIG. 4). Additional evidence that the urethane linkage had formed is the presence of the amide II peak near 1540 cm⁻¹ as well as the −NH/OH peak at 3400 cm⁻¹. ¹H-NMR of the product found in FIG. 5 shows the presence of protons corresponding to the double bond of maleimide. Further the protons associated with the two carbon atoms between the maleimide group and the urethane linkage (b and c) have shifted slightly upfield due to the creation of the urethane linkage.

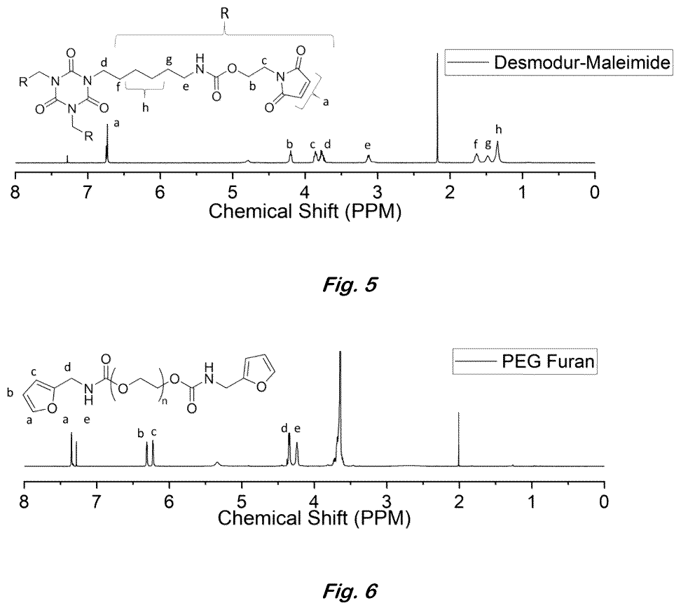

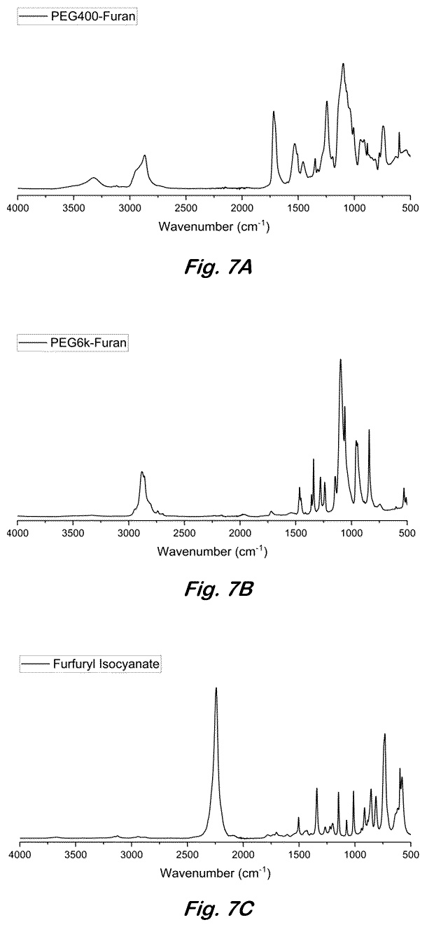

ATR-IR analysis was also performed on the PEG Furan products (FIGS. 7A-C). The products were also confirmed by the disappearance of the isocyanate peak from furfuryl isocyanate and the appearance of the carbonyl peak and amide II peak of the urethane linkage. The presence of the protons from the double bonds of the furan functional group present in the ¹H-NMR (FIG. 6) provided additional evidence that reaction was successful. These data confirm the complete conversion of starting materials to their respective DA modified products for subsequent polymerization into dynamic covalent networks.

Polymerization—From the synthesized monomers, a series of polymers were prepared based on the maleimide-modified Desmodur and furan-modified diols. The maleimide-modified Desmodur was held constant and coupled with furan-modified PEG diols of 400 g/mol and 6,000 g/mol in relative ratios of 100:0, 75:25, 50:50, 25:75, and 0:100 of PEG 400 to 6,000 g/mol, respectively. The polymers were slightly over-indexed in maleimide, a strategy similarly employed in commercial polyurethane coatings, with a slight molar access of maleimide functional group to furan of 1.1:1, respectively. The effect of molecular weight (M_{w}) of the PEG diols on the subsequent polymer mechanical properties was evaluated. The nomenclature and compositional details of the polymers are shown in Table 1.

TABLE 1
Polymer composition

| Sample Name | Mal:Furan (ratio) | PEG400 | PEG6k |
|---|---|---|---|
| 100PEG 400 | 1.1:1 | 1.0 | 0 |
| 75PEG 400-25PEG6k | 1.1:1 | 0.75 | 0.25 |
| 50PEG 400-50PEG6k | 1.1:1 | 0.50 | 0.5 |
| 25PEG 400-75PEG6k | 1.1:1 | 0.25 | 0.75 |
| 100PEG6k | 1.1:1 | 0 | 1.0 |

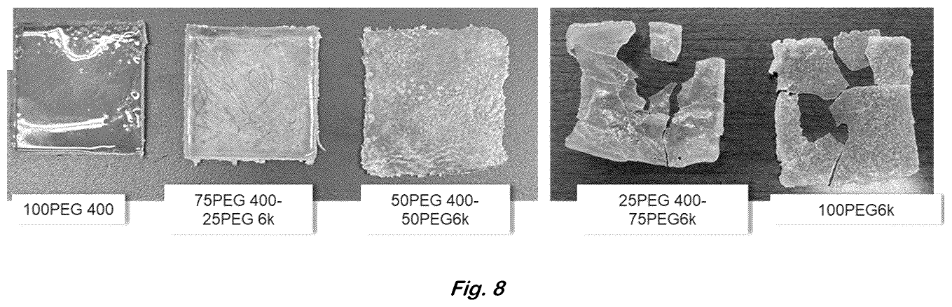

Free films were prepared by adding components to a scintillation vial with a small amount of dichloromethane. Specifically, urethane-based DA components were dissolved in dichloromethane and solvent cast into Teflon molds and allowed to cure at 65° C. for 17 h. This allowed the solvent to evaporate from the mixture while also allowing for the DA adduct to form, thus polymerizing the two components. This method to prepare free films represents a facile and reproducible approach to create polymers to test and evaluate physical and thermomechanical properties. Slightly brown, largely transparent free films were produced from all formulations (FIG. 8). Free films with higher ratios of PEG400 as the diol component exhibited the most uniform and smooth free films. Increased ratio of PEG6K in the polymer formulation resulted in increased cloudiness and brittleness of the free films, which was attributed to the higher crystallinity of PEG6K compared to PEG400.

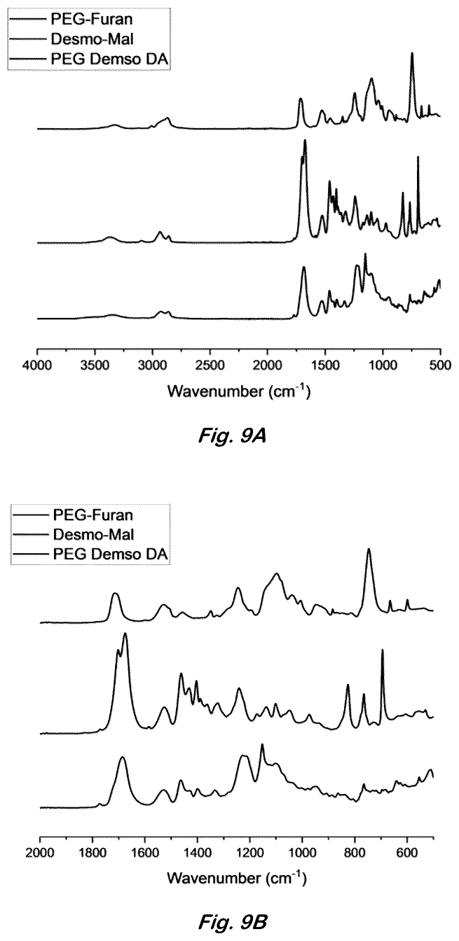

PU-DA polymerfreefilm characterization—Initial polymerization of PEG6K-furan and Desmo-Mal was evaluated with ATR-IR (FIGS. 9A-B). First, ATR-IR analysis confirms the complete reaction of the isocyanate group with diol in the initial modification of the PU starting materials by the absence of the —NCO peak near 2200 cm⁻¹, as well as the formation of the urethane carbonyl peak ˜1700 cm⁻¹ and the amide II band near 1540 cm⁻¹ (FIG. 9A). Closer analysis of the fingerprint region (FIG. 9B) indicates the PEG-Furan group has a sharp peak at 747 cm⁻¹ that is attributed to the C—H stretching from the aromatic ring of the furan group. In Desmo-Mal, the C—N group of the maleimide is observed at 1324 cm⁻¹. The monomers PEG-Furan and Desmo-Mal were mixed and polymerized. After polymerization, peaks from the PEG6K-furan and maleimide groups lost intensity and a new peak at 1152 cm¹ formed, which was attributed to the C—O—C of the DA adduct. These results suggest successful reaction of the Desmo-Mal and PEG6K-furan to form a DA-based polymer film.

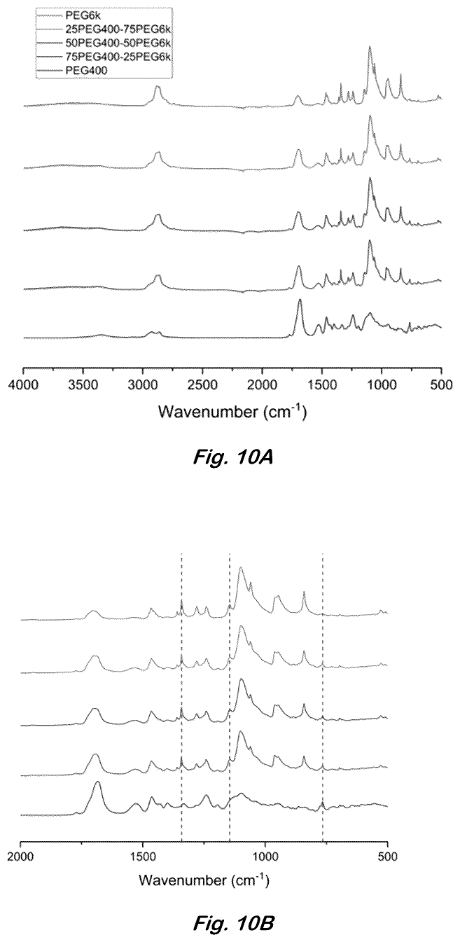

The effect of diol Mw and diol composition on the polymerization with ATR-IR analysis of post-cured free films was evaluated (FIGS. 10A-B). The conversion of free furan and maleimide into the DA adduct was monitored by the relative intensity of peaks at 747 cm⁻¹ and 1324 cm⁻¹, which correspond to the aromatic rings of the furan and the C—N stretch of the maleimide, respectively, and the peak at 1152 cm⁻¹, which corresponds to the C—O—C ether of the DA adduct. The intensity of the broad and strong peak centered at approx. 1100 cm⁻¹, which corresponds to C—O—C ether of the PEG chain, increases with increasing concentration of PEG6K in the formulations. In all PU-DA samples, the furan peaks at 747 cm⁻¹ were very weak, which suggests minimal free furan present. Further, all PU-DA films also exhibited minor maleimide peaks at 1324 cm⁻¹, the presence of which was attributed to the slight molar excess of maleimide to furan from the 1.1:1 over-indexing ratio. Finally, all PU-DA samples exhibit a peak at 1152 cm⁻¹ indicative of DA coupling of the furan and maleimide components in the PU-DA system. Overall, good conversion of monomers to polymer was confirmed through appearance of polymer bands and decrease in free furan and maleimide bands.

The role of polymer composition, specifically the M_{w} of the diol component and relative ratios of PEG400/PEG600, on the polymer properties were evaluated. The free films were subjected to gel fraction analysis to evaluate the degree of cross-linking and polymerization efficiency. Thermomechanical properties were measured using DMA. Polymer properties from both tests are shown in Table 2. Higher PEG400 content in the free films resulted in improved crosslinking, with 100PEG 400 and 75PEG 400-25PEG 6k exhibited gel fractions of 84.4±0.7% and 89.6±1.9, respectively, as compared to 61.1±1.2% for 50PEG 400-50PEG 6k. This was attributed to the increased DA crosslinking, which resulted from the higher mobility of the shorter chain PEG groups that allowed PEG400 furan end groups to more effectively find and react with a corresponding maleimide group. Indeed, glass transition temperatures (T_{g}) obtained from DMA indicated a direct relationship between T_{g} and PEG400 content. Specifically, T_{g} increases with increasing PEG400 composition. A lower T_{g} is generally indicative of greater chain mobility, which would allow for higher rate of DA adduct formation. Correspondingly, an inverse relationship between modulus and PEG400 occurred as greater chain mobility of lower MW PEG results in softer and more flexible free films. Importantly, the range of T_{g} for these free films is comparable to military grade PUs, which conventionally exhibit T_{g} ˜20-40° C.⁴ As such, the polymer properties of the DA polymer series can be easily tuned by modulating the PEG-furan M_{w}. This has potential to serve as a facile approach to formulate DA coatings to target military coating specifications.

TABLE 2
Polymer properties

| Sample Name | Gel Fraction (%) | Tg (° C.)^{a} | Modulus (MPa) |
|---|---|---|---|
| 100PEG 400 | 84.4 ± 0.7 | 38.1 | 40.67 |
| 75PEG 400-25PEG 6k | 89.6 ± 1.9 | 35.0 | 169.76 |
| 50PEG 400-50PEG 6k | 61.1 ± 1.2 | 20.2 | 123.58 |

^{a}T_{g} measured with DMA

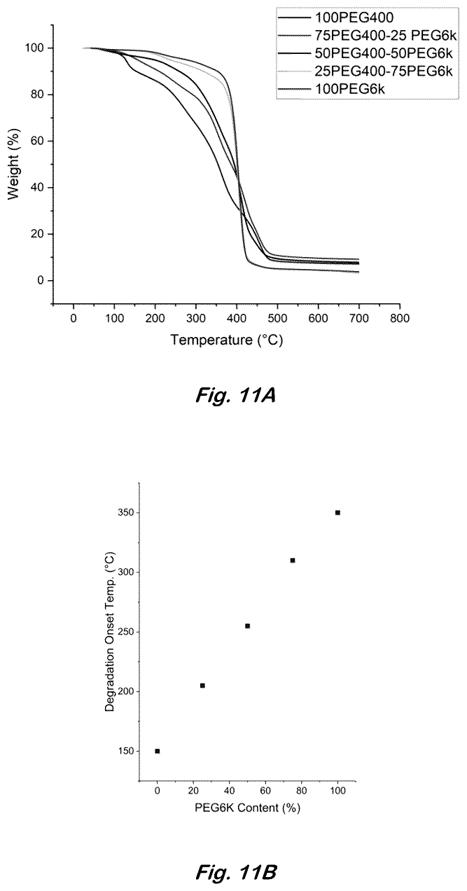

The effect of PEG molecular weight on the thermal properties of the free films was evaluated using TGA (FIGS. 11A-B). There was a direct relationship between the degradation onset temperature (temperature at which 90% remains) and PEG MW of the polymer formulation. Specifically, degradation onset temperature increased with increased PEG6K content in the free films (FIG. 11B). 100PEG400 exhibited relatively low thermal stability with a degradation onset at approx. 150° C., whereas the degradation onset temperature of 100PEG6K was ˜350° C. Conventional crosslinked PUs used for coating applications typically have degradation onset temperature in the range of 250-300° C.⁴ As such, some amount of PEG6K is required in the formulation to achieve a comparable onset degradation temperature to convention military grade coatings.

It is hypothesized that the low degradation onset temperature of the 100PEG400 polymers may result from the DA retro-DA reaction that is known to become favored at high temperatures, typically greater than 120° C. Coincidentally, this is approximately the temperature at which the initial mass loss of 100PEG400 occurred. Therefore, it is proposed that at elevated temperatures (ca. 120° C.) the retro-DA reaction begins to occur in the 100PEG400 resulting in reformation of the PEG-furan and Desmo-Mal monomers, which begin to volatilize to cause a mass loss.

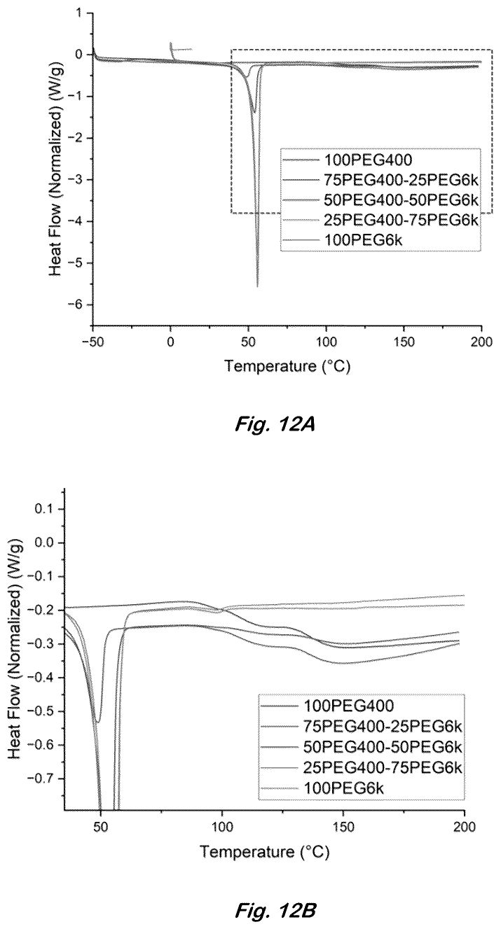

Thermal properties and transitions of the PU-DA free films were evaluated using DSC across a temperature ramp from −50-200° C. (FIGS. 12A-B). All samples that contained PEG6K exhibited sharp endotherms at approximately 50° C., which was attributed to the melting of the PEG6K component of the PU-DA formulations. This peak was completely absent in 100PEG400 as PEG400 is not crystalline in this temperature range. In contrast, only samples that contained PEG400 in the formulation exhibited T_{g}, where the range of 100-140° C. for the sample series. Interestingly, the T_{g} as measured by DSC differed significantly from those measured via DMA (Table 2). Hysteresis of up to approx. 15° C. are common among T_{g} measured between DMA and DSC, however here the difference is much larger.

Dynamic analysis—The prepared PU-DA free films were subjected to a series of dynamic analyses to evaluate potential for retro-DA reaction, the effect of PEG MW on behavior, and to demonstrate feasibility for potential applications.

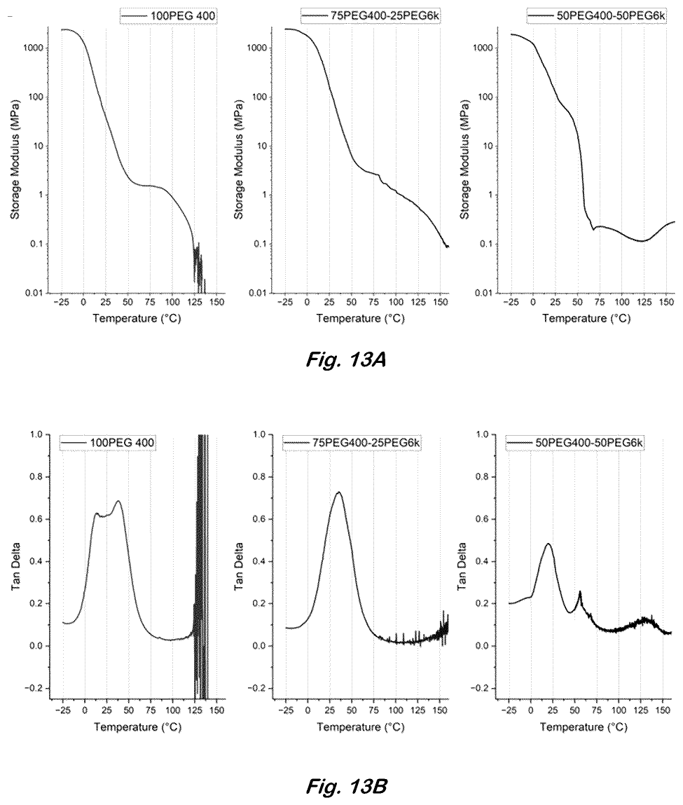

Thermomechanical properties were measured to evaluate dynamics of thermoreversible DA network in cross-linked polymers. The viscoelastic properties of the PU-DA films were analyzed with DMA, as shown in FIGS. 13A-B. The temperature was ramped from −25° C. through 150° C. at a 3° C. min⁻¹ heating rate. The storage modulus curves indicate a plateau in the glassy region, but the characteristic plateau in the rubbery region is absent (FIG. 13A). Instead, the modulus continues to decrease as the temperature increased due to formation of the retro-DA state of the polymer matrix. The tan δ plots all indicate that the ratio of G″/G′ are all tan δ<1 (FIG. 13B). This indicates viscous mechanisms will have a greater influence on the properties of the material. Notably, the storage modulus of 100PEG400 dramatically decreases from 75-120° C., at which point the data becomes noisy due to loss of mechanical integrity of the sample. This behavior supports the previous results in the TGA ramps, where thermal properties of 100PEG400 decreased in a similar temperature regime. These data further support the hypothesis that the retro-DA is indeed occurring in the 100PEG400 films at temperatures approaching 120° C.

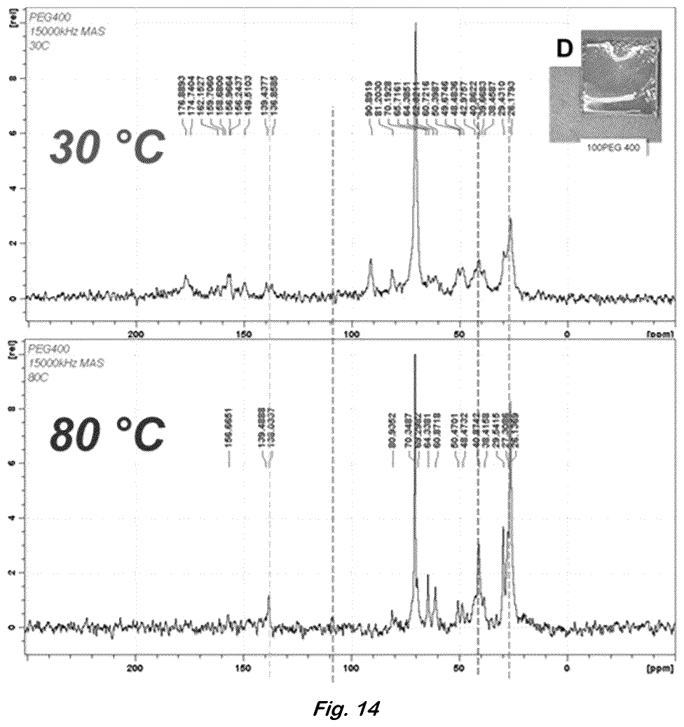

The molecular dynamics of the 75PEG 400-25PEG 6k PU-DA films were directly analyzed using ssNMR to determine the role of temperature on the degree of polymerization (FIG. 14). PU-DA free films were ground into powders by first freezing with liquid nitrogen then grinding with mortar and pestle. These powders were used for ssNMR with spectra acquired using a standard solid NMR cross-polarization experiment, with 512 scans, and spinning at 15 kHz. Current spectra were acquired across a temperature range of 30° C. to 50° C. using a high temperature probe. The spectra are normalized to the tallest peak at 70.7 ppm, which elucidates decreases in most peaks across the spectrum. While this temperature range is still well below the 120° C., above which temperature it is expected the reaction kinetics to favor the retro-DA reaction, it can be assumed that with increasing temperature the retro reaction to be become relatively more prevalent. If so, then ¹³C peaks corresponding to DA adduct would be expected to decrease in intensity and free furan and free maleimide ¹³C to emerge or increase in intensity. As such, preliminary analysis indicates that this may be occurring.

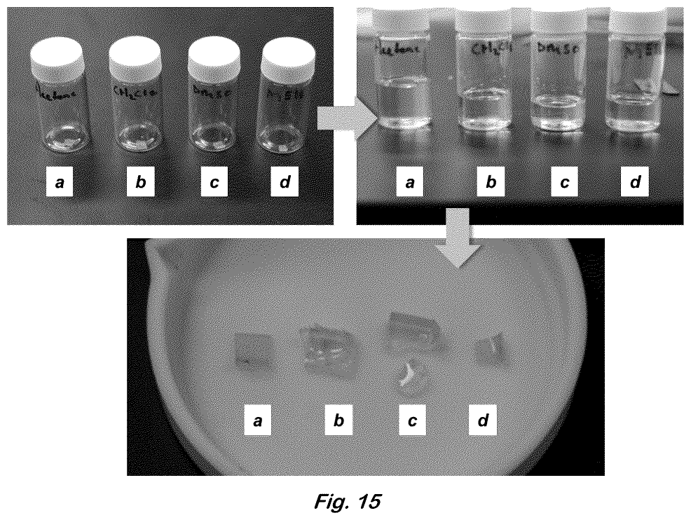

Cross-linked polymers, and specifically PUs, are often used as polymer coatings due to their thermal and chemical (solvent) resistance properties. The same durability to thermal and chemical stimuli inherently results in difficulty removing or reprocessing the same polymer material. A significant benefit of the PU-DA system is the potential to exhibit ambient temperature solvent resistance and also high temperature thermal repressibility, similar to a thermoplastic. Therefore, the PU-DA 100PEG400 free film was subject to ambient temperature (20° C.) solvent resistance challenge to assess its feasibility to exhibit durability similar to a convention cross-linked coating (FIG. 15). 100PEG400 was divided into four samples and each was submerged in a strong solvent overnight. The four strong solvents used were acetone, dichloromethane, dimethylsulfoxide (DMSO), and methyl ethyl ketone (MEK). 100PEG400 did not dissolve in any of the solvents when fully submerged for 18 h. The 100PEG400 samples did swell in dichloromethane and DMSO, with greatest swelling occurring in DMSO to the extent that the film broke into two pieces. The solvent durability shown by 100PEG400 is indicative of a crosslinked, or thermoset, polymer. Overall, this evaluation clearly demonstrates the excellent solvent stability of the 100PEG400 polymer.

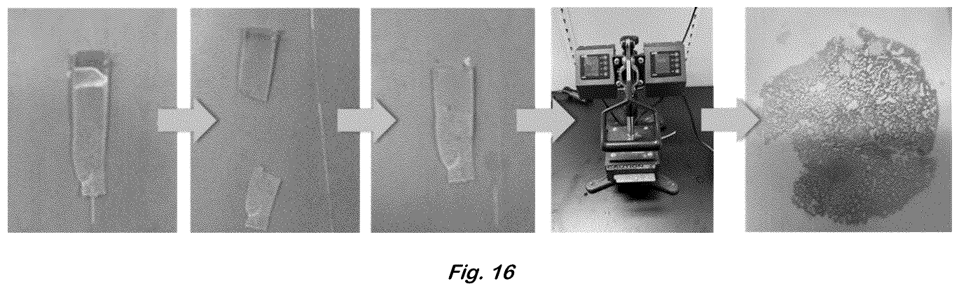

Fully cured 100PEG400 PU-DA free films were subjected to high temperature reprocessing evaluation to assess their capability to reform and reprocess at elevated temperatures. Small 5 cm×1 cm samples of 100PEG400 were prepared, then cut in half, overlaid, placed between Teflon release films, and then subjected to 165° C. heat press for 17 h (FIG. 16). The heat temperature of 165° C. was selected because it is well in the temperature region where the retro-DA is known to dominate kinetics. The mechanical flexibility of the 100PEG400 enabled easy preparation and cutting to prepare the overlay. Upon heating at 165° C., the rectangular overlay deformed into a thin, circular, and discontinuous film. The discontinuity of the film was attributed the low surface energy of the Teflon release film, which facilitated the spinodal-like decomposition of the film to cause holes and openings. The reprocessed film properties and morphology can be easily tuned with optimization of thermal treatment and substrate selection. While the appearance and morphology of the reprocessed film was not ideal, it does clearly demonstrate the feasibility to thermally reprocess the 100PEG400 film into a different form factor, as would occur during recycling or coating reuse applications. If the polymer films were cross-linked as in conventional non-dynamic covalent networks (i.e., PUs), then the films would not change shape under load at high temperature. Overall, the thermal reformation of 100PEG400, in combination with the ambient temperature solvent resistance, provided evidence of a cross-linked dynamic covalent network.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

### REFERENCES

(1) Kathalewar, M. S.; Joshi, P. B.; Sabnis, A. S.; Malshe, V. C. Non-isocyanate polyurethanes: from chemistry to applications. RSC Advances 2013, 3 (13), 4110-4129, 10.1039/C2RA21938G. DOI: 10.1039/C2RA21938G.
(2) Chattopadhyay, D. K.; Raju, K. V. S. N. Structural engineering of polyurethane coatings for high performance applications. Progress in Polymer Science 2007, 32 (3), 352-418. DOI: https://doi.org/10.1016/j.progpolymsci.2006.05.003.
(3) Giles, S. L.; Heller, N. W. M.; Clayton, C. R.; Walker, M. E.; Wytiaz, M. J.; Wynne, J. H. Novel Methods of Producing Low-Reflectance Coatings Utilizing Synergistic Effects of Polymer Phase Separation. ACS Applied Materials & Interfaces 2016, 8 (39), 26251-26257. DOI: 10.1021/acsami.6b06037.
(4) Daniels, G. C.; Camerino, E.; Wynne, J. H.; Iezzi, E. B. Cross-linked networks that selectively and controllably disassemble on-demand via cascading bond cleavage. Materials Horizons 2018, 5 (5), 831-836, 10.1039/C8MH00117K. DOI: 10.1039/C8MH00117K.
(5) Scheutz, G. M.; Lessard, J. J.; Sims, M. B.; Sumerlin, B. S. Adaptable Crosslinks in Polymeric Materials: Resolving the Intersection of Thermoplastics and Thermosets. Journal of the American Chemical Society 2019, 141 (41), 16181-16196. DOI: 10.1021/jacs.9b07922.
(6) van den Tempel, P.; Picchioni, F.; Bose, R. K. Designing End-of-Life Recyclable Polymers via Diels-Alder Chemistry: A Review on the Kinetics of Reversible Reactions. Macromolecular Rapid Communications 2022, 43 (13), 2200023. DOI: https://doi.org/10.1002/marc.202200023.
(7) Ratwani, C. R.; Kamali, A. R.; Abdelkader, A. M. Self-healing by Diels-Alder cycloaddition in advanced functional polymers: A review. Progress in Materials Science 2023, 131, 101001. DOI: https://doi.org/10.1016/j.pmatsci.2022.101001.
(8) Stevens, M. P.; Jenkins, A. D. Crosslinking of polystyrene via pendant maleimide groups. Journal of Polymer Science: Polymer Chemistry Edition 1979, 17 (11), 3675-3685. DOI: https://doi.org/10.1002/pol.1979.170171123.
(9) Chen, X.; Dam, M. A.; Ono, K.; Mal, A.; Shen, H.; Nutt, S. R.; Sheran, K.; Wudl, F. A Thermally Re-mendable Cross-Linked Polymeric Material. Science 2002, 295 (5560), 1698-1702. DOI: doi:10.1126/science.1065879.
(10) Burattini, S.; Greenland, B. W.; Chappell, D.; Colquhoun, H. M.; Hayes, W. Healable polymeric materials: a tutorial review. Chemical Society Reviews 2010, 39 (6), 1973-1985, 10.1039/B904502N. DOI: 10.1039/B904502N.
(11) Schäfer, S.; Kickelbick, G. Double Reversible Networks: Improvement of Self-Healing in Hybrid Materials via Combination of Diels-Alder Cross-Linking and Hydrogen Bonds. Macromolecules 2018, 51 (15), 6099-6110. DOI: 10.1021/acs.macromol.8b00601.
(12) Sanyal, A. Diels-Alder Cycloaddition-Cycloreversion: A Powerful Combo in Materials Design. Macromolecular Chemistry and Physics 2010, 211 (13), 1417-1425. DOI: https://doi.org/10.1002/macp.201000108.

What is claimed is:

1. A polymer made by a method comprising:
providing a maleimide monomer comprising maleimidyl groups and having the formula: 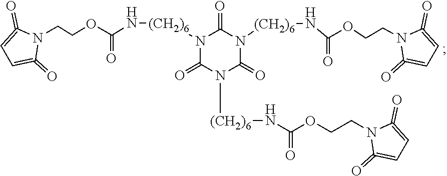
providing a furan monomer comprising furyl groups and having the formula: 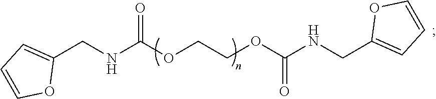
wherein n is a positive integer;
combining the maleimide monomer with the furan monomer to form a composition; and
reacting at least one of the maleimidyl groups with at least one of the furyl groups to form a polymer comprising at least one crosslinking group having the formula:

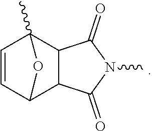

2. The polymer of claim 1, wherein n is at least 8.

3. The polymer of claim 1, wherein the furan monomer comprises two or more of the furan monomers having different values of n.

4. The polymer of claim 1, wherein the molar ratio of the maleimidyl groups to the furyl groups in the composition is from 1.0:1 to 1.2:1.

5. A method comprising:
heating the polymer of claim 1 to convert at least one of the crosslinking groups to the maleimidyl group and the furyl group.

6. A method comprising:
providing a maleimide monomer comprising maleimidyl groups and having the formula: 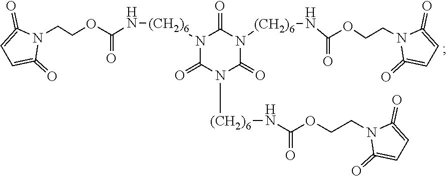
providing a furan monomer comprising furyl groups and having the formula: 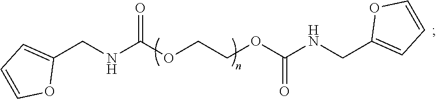
wherein n is a positive integer;
combining the maleimide monomer with the furan monomer to form a composition; and
reacting at least one of the maleimidyl groups with at least one of the furyl groups to form a polymer comprising at least one crosslinking group having the formula:

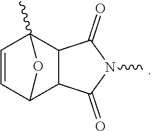

7. The method of claim 6, wherein n is at least 8.

8. The method of claim 6, wherein the furan monomer comprises two or more of the furan monomers having different values of n.

9. The method of claim 6, wherein the molar ratio of maleimidyl groups to furyl groups in the composition is from 1.0:1 to 1.2:1.

10. A maleimide monomer comprising maleimidyl groups and having the formula:

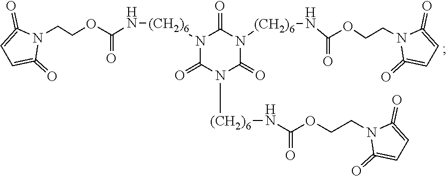

11. A composition comprising:
the maleimide monomer of claim 10; and
a furan monomer comprising furyl groups and having the formula: 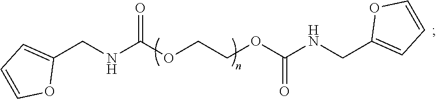
wherein n is a positive integer.

12. The composition of claim 11, wherein n is at least 8.

13. The composition of claim 11, wherein the furan monomer comprises two or more of the furan monomers having different values of n.

14. The composition of claim 11, wherein the molar ratio of the maleimidyl groups to the furyl groups in the composition is from 1.0:1 to 1.2:1.
